(19) United States
(12) Patent Application Publication
(10) Pub. No.: US 2004/0193906 A1
(43) Pub. Date: Sep. 30, 2004

(54) Network service security

(76) Inventors: Shual Dar, Tel Aviv (IL); Boaz Kantor, Ramat Hasharon (IL); Eden Shochat, Ra'ananna (IL)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/395,805

(22) Filed: Mar. 24, 2003

(51) Int. Cl. H04L 9/00

(52) U.S. Cl. 713/200

(57) ABSTRACT

A system for use in a network that includes a plurality of clients and a plurality of servers configured to implement service applications includes at least one interface configured to communicate with the clients and the servers, a memory that contains computer-readable and computer-executable instructions and an access control list with sets of associated client identification and destination service identification, and a processor coupled to the at least one interface and to the memory and configured to read the instructions, the instructions being configured to cause the processor to: analyze an incoming service-access request, received by the at least one interface, for source identification associated with a source of the service-access request and destination service identification associated with an intended destination of the server-access request, the source identification comprising at least one of network source address and a source port number, and the destination service identification comprising at least one of a destination service address and a destination port number; and determine whether indicia of the source identification and of the destination service identification from the service-access request is included in the access control list in a manner that indicates that the source of the service-access request is authorized for access to a service associated with the destination service identification.

### FIELD OF THE INVENTION

The invention relates to network service security and regulating accessibility to server-provided services.

### BACKGROUND OF THE INVENTION

Network servers provide a wide array of services to clients connected to the servers via a network. The servers run programs to provide services such as web content, FTP, email, e-commerce, printing, graphics, audio and/or video services, etc. Client requests are relayed via the network to a server that contains the program to provide the service needed by the request. Different servers may provide the same service content, although the service qualities may differ, e.g., in data transfer speed and/or data error rate. Different programs being run on the clients may want to use the services, and it is often desirable to regulate which clients have access to the various services. For example, web content providers may want to restrict some clients from accessing their web content, or the manner in which the clients access the content such as by allowing students to access search engines for free while charging companies for the same access. Further, email or graphics services may be restricted to clients that have subscribed to the services.

Referring to FIG. 1, a typical client-network-server configuration 500 includes clients 502, a network 504, and several servers 506. The servers 506 include software programs that use stored data for providing services. The clients 502 run applications that communicate with the servers 506 to obtain the services. The client applications include applications that automatically request services, and applications where service requests are user initiated (e.g., TelNet, printing). The clients 502 may be applications servers, end user workstations, etc., and may access the servers 506 via the network 504 that is typically a packet-switched network, e.g., the Internet. Access to one or more of the services provided by the servers 506 may be limited, e.g., by the servers 506 requiring a user of the client 502 to provide a login ID and a password. U.S. Pat. No. 5,835,727 discusses a method of controlling access to services within a computer network where a user provides a password to obtain desired access.

In network communications, it is often desirable to conceal the actual identifier (address and/or port number) of servers associated with services. To help conceal the actual identifier of a service, the service may be identified using a virtual service identifier that comprises a virtual network address and/or a virtual port number. This virtualization can help control access to servers and allow for management of service requests. For example, multiple servers may provide the same service, and communications directed to a service may be selectively routed to any of the possible servers, e.g., for load balancing purposes or because of a predetermined association of a particular client and a particular server, etc.

### SUMMARY OF THE INVENTION

In general, in an aspect, the invention provides a system for use in a network that includes a plurality of clients and a plurality of servers configured to implement service applications. The system comprises at least one interface configured to communicate with the clients and the servers, a memory that contains computer-readable and computer-executable instructions and an access control list with sets of associated client identification and destination service identification, and a processor coupled to the at least one interface and to the memory and configured to read the instructions, the instructions being configured to cause the processor to: analyze an incoming service-access request, received by the at least one interface, for source identification associated with a source of the service-access request and destination service identification associated with an intended destination of the server-access request, the source identification comprising at least one of network source address and a source port number, and the destination service identification comprising at least one of a destination service address and a destination port number; and determine whether indicia of the source identification and of the destination service identification from the service-access request is included in the access control list in a manner that indicates that the source of the service-access request is authorized for access to a service associated with the destination service identification.

Implementations of the invention may include one or more of the following features. The instructions are configured to cause the processor to analyze the incoming service-access request for a virtual destination address as the destination identification information. The instructions are further configured to cause the processor to determine whether the indicia of the source identification is stored in the access control list in association with the indicia of the destination service identification and an associated indication of whether the requested access is authorized. The instructions are further configured to cause the processor to inhibit the service-access request from reaching a server associated with the destination service identification if the processor determines that the source of the service-access request is unauthorized for access to a service associated with the destination service identification. The instructions are configured to cause the processor to inhibit the service-access request if the processor fails to find the indicia of the source identification in the access control list, or finds the source identification in the access control list but the indicia of the destination service identification is not associated with the source identification, or finds the source identification in the access control list associated with the indicia of the destination service and an associated indication that indicates that the requested access is unauthorized.

Implementations of the invention may also include one or more of the following features. The access control list contains indicia of a range of at least one of source address, source port number, destination service address, and destination service port number. The instructions are further configured to cause the processor to inhibit the server-access request from reaching the server associated with the destination identification indication if the processor fails to determine that the indicia of the network source address indicated by the server-access request is included in the access control list in association with the indicia of the destination identification information indicated by the server-access request.

In general, in another aspect, the invention provides a method of selectively conveying communications from a client toward a service in a packet-switched network The method comprises receiving a data packet, determining, from a header of the packet, a source identifier and a destination service identifier, the source identifier comprising at least one of a network address and a source port number, and the destination service identifier comprising at least one of a destination address and a destination port number, determining, using stored relationships of indicia of source identifiers and indicia of destination service identifiers, whether a client associated with the source identifier is authorized to access a service associated with the destination service identifier, and transmitting data contained in the packet toward the service if the client associated with the source identifier is authorized to access a service associated with the destination service identifier.

Implementations of the invention may include one or more of the following features. The transmitting occurs regardless of values of payload data in the packet. The method further includes inhibiting the data contained in the packet from being transmitted toward the server if the searching fails to find that the client associated with the source identifier is authorized to access a service associated with the destination service identifier. The determining includes analyzing an authorization indication associated with the stored relationships.

In general, in another aspect, the invention provides a system for selectively conveying communications from clients toward servers, that provide services. The system comprises at least one interface configured to communicate with the clients and the servers, and means for determining whether an incoming communication, that includes logistical information and substantive information, is from one of the clients that is authorized to access a service, provided by at least one of the servers, to which the communication is intended, the determining being independent of the substantive information contained in the communication.

Implementations of the invention may include one or more of the following features. The communication comprises a packet of data including header information and payload data and wherein the determining means performs the determining based only on the header information. The determining means performs the determining using stored authorization associations of indicia of client identifiers and indicia of corresponding authorized services. The determining means performs the determining using stored authorization associations of indicia of at least one of client network addresses and port numbers. The system further comprises means for inhibiting the communication from reaching the intended service if the client from which the communication came is unauthorized to access the intended service.

Various aspects of the invention may provide one or more of the following advantages. Inadvertent security violations, e.g., due to client applications accessing services for which they are not authorized, may be avoided. Intentional, malicious, security violations of service programs may also be avoided. Reports of potential security violations may be produced. Indicia may be provided regarding a source of a would-be security violation, e.g., an unauthorized client-application combination attempting to improperly access a service program, such as a database service. An administrator can define acceptable pairings of client-application combinations and services. Access by specific clients and/or multiple clients, e.g., from a range of network addresses, may be regulated by inhibiting access to the services or by specifically allowing access to the services. Modifications can be made regarding authorized and unauthorized service accesses without substantially affecting throughput of service requests.

These and other advantages of the invention, along with the invention itself, will be more fully understood after a review of the following figures, detailed description, and claims.

### BRIEF DESCRIPTION OF THE FIGURES

FIG. 1 is a simplified diagram of a typical database network implementation.

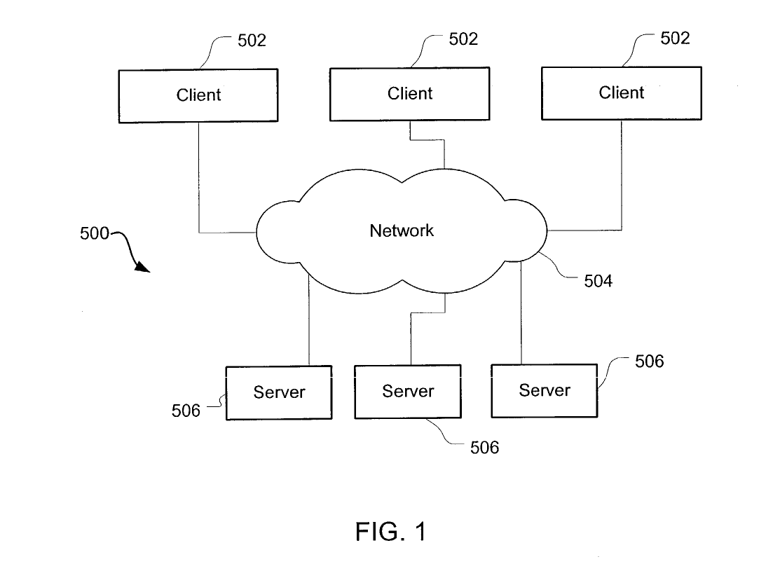

FIG. 2 is a simplified diagram of a network including a switch configured to implement an access control list.

FIGS. 3A-3B are simplified block diagrams of components of the switch shown in FIG. 2.

FIG. 4A is an example of an access filtering specification reflecting relationships between services, applications, and clients and whether access to the services is permitted.

FIG. 4B is an example of a virtual access control list, translated from an access filtering specification, relating addresses and port numbers of clients/applications and services with indicia of whether access to the services by the clients/applications is permitted.

FIG. 4C is an example of an actual access control list translated from an access filtering specification.

FIG. 5 is a block flow diagram of a process of restricting access to services by the switch shown in FIG. 2 using an access control list stored in the switch.

### DETAILED DESCRIPTION OF PREFERRED EMBODIMENTS

Some embodiments of the invention provide techniques for securing network service access. For example, a system according to some embodiments of the invention can provide the ability to produce, modify, and maintain relationships between clients and/or client applications and services to which the clients and/or applications are allowed and/or denied access. The relationships are stored in an access filtering specification controlling which applications on which clients in a network are allowed access to which services, such as database services, in the network. A user can establish and modify the access filtering specification as to the relationships and whether they indicate that access to corresponding services is permitted or not permitted. The filtering specification is translated to an access control list that can be implemented by standard routing techniques in a standard router. Attempts at unauthorized access can be determined independently of input from a user of the client, such as by analyzing a network address of the client and a port associated with a service-access request. Unauthorized access attempts can be inhibited, including being blocked and/or reported. Other embodiments are within the scope of the invention.

As an example, the following description discusses database services and a database managing switch. The invention, however, is not limited to database servers, database managing switches, or database services as other types of servers, managing switches, and/or services are acceptable and within the scope of the invention. For example, the servers could be configured to provide any of a wide range of services such as web content, FTP, email, e-commerce, printing, graphics, audio and/or video services, etc.

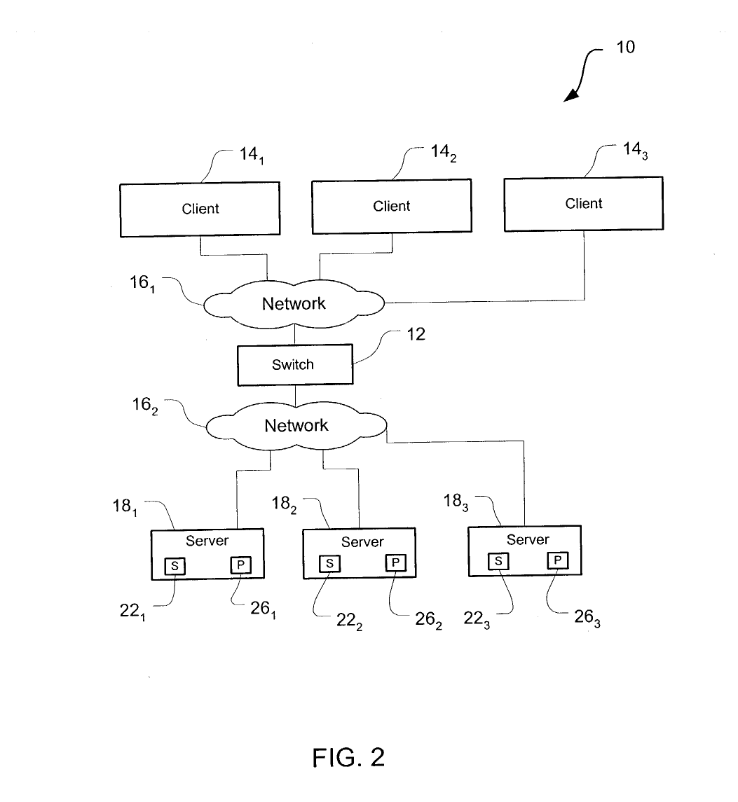

Referring to FIG. 2, a communication system 10 includes a database switch (switch) 12, three clients 14, two networks 16, and three servers 18₁-18₃. While three clients 14 and three servers 18 are shown, the system 10 is scalable such that other quantities of the clients 14 and/or the servers 18 are possible and would be acceptable. If the servers 18 are database servers, then the switch 12 is a database switch (switch), and the system 10 includes storage for the servers 18 (shared storage and/or individual, local storage for the servers 18). The system 10 is configured for packetized data communications, e.g., with the networks 16 being a packet-switched communication networks or portions thereof such as portions of local area networks (LAN), wide area networks (WAN), or the global packet-switched network known as the Internet. Packets of data transferred in the system 10 include source and destination identifiers including addresses, e.g., Internet Protocol (IP) addresses, and/or port numbers.

The servers 18 include software 22 that includes Database Management System (DBMS) software including database programs (called database instances for Oracle® servers) that are assigned to the various servers 18. The servers 18₁-18₃ include processors, e.g., CPUs, 26₁-26₃ that are configured to perform tasks according to the computer-readable and computer-executable software 22.

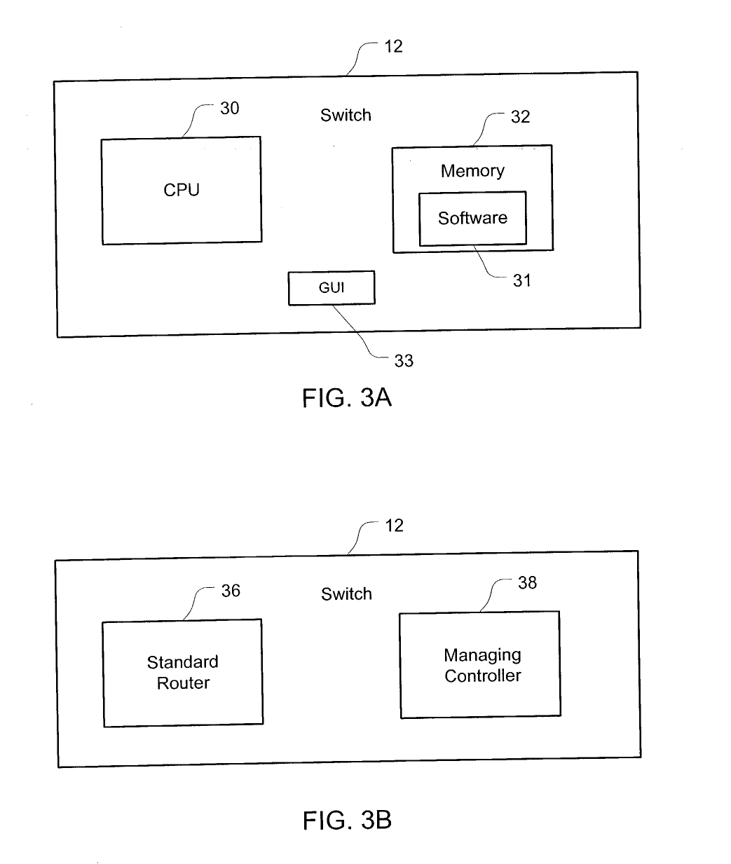

Referring also to FIG. 3A, the switch 12 includes a processor 30, a memory 32, and an interface 33. The user interface 33, e.g., a graphical user interface (GUI) is configured to allow interaction between a user and the switch 12. For example, the user can supply indicia of which client applications can access which services and the memory 32 can store these indicia, and related indicia determined by the processor 30. Referring also to FIG. 3B, the switch 12 includes a router 36 and a managing controller 38. As shown and preferred, the router 36 and the controller 38 are implemented as separate physical devices, but may be implemented as a single device. The following description refers to the router 36 and/or the controller 38 as the switch 12. The router 36 can perform typical router functions including network address translation (NAT) from virtual addresses to actual addresses and vice versa, routing of packets, and using access control lists (ACLs). The managing controller 38 is configured to operate on communications transferred through the switch 12, e.g., to regulate access of communications to intended services, and to control the router 36 to perform functions described below.

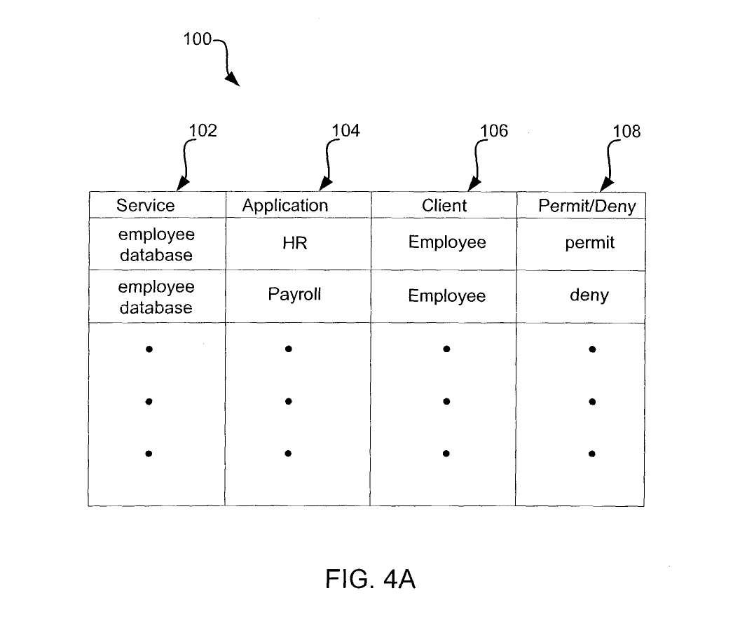

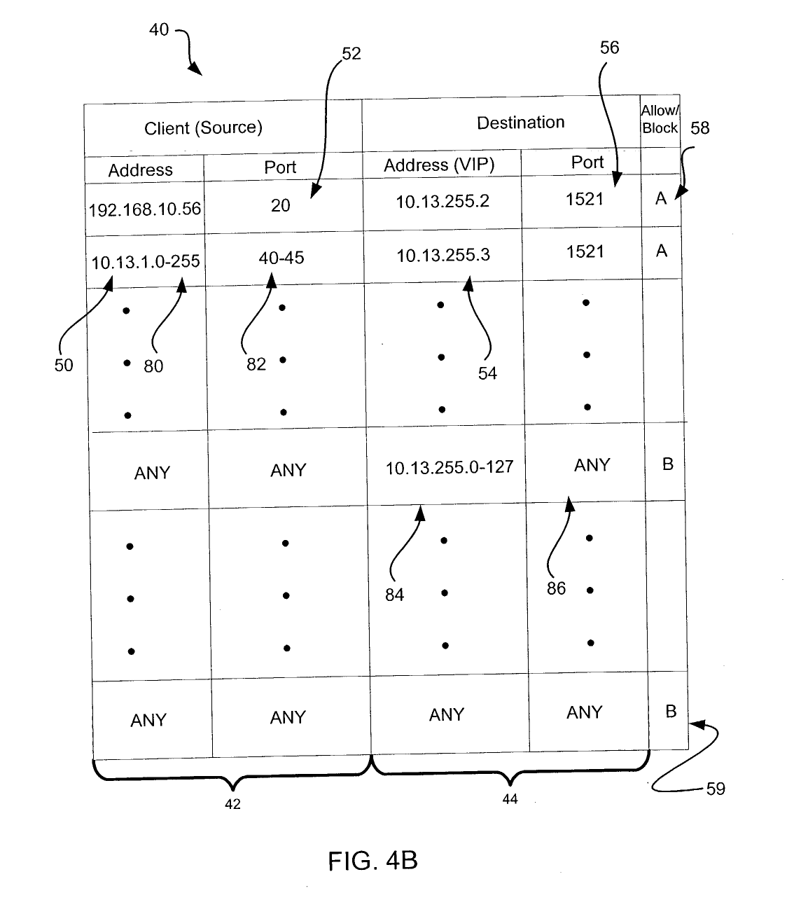

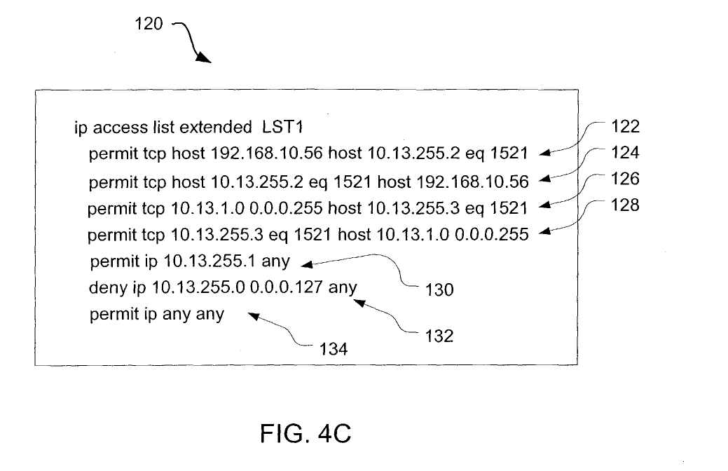

Referring to FIGS. 3A, 3B, and 4A, the switch 12 is configured to receive and store indicia of which client applications can access which services. The user can input data using the interface 33, that the switch stores in an access filtering specification 100, to indicate that particular clients 106 and applications 104 should be permitted or denied (as indicated by a permit/deny indicator 108) access to corresponding services 102. The switch 12 is further configured to translate the filter specification 100 into an access control list to be stored in and implemented by the router portion 36 of the switch 12.

Referring also to FIG. 4B, the switch 12 can translate the filter specification 100 into a virtual access control list (ACL) 40 for regulating access by clients and/or applications to services, and store the virtual ACL 40 in the memory 32. The virtual ACL 40 is produced and maintained with input from the switch's user through the interface 33 according to which clients and/or client applications are allowed or denied access to respective services. The virtual ACL 40 associates client application identifiers 42, including actual client addresses 50 and/or port numbers 52, with virtual service identifiers 44, including destination addresses 54 and/or port numbers 56, and indications 58. The client identifiers 42 are provided by the clients 14 without input from a user of the client 14 and identify the client and client application. The client identifiers 42 and the service identifiers 44 can be determined from headers of packets, as opposed to payloads of the packets, received by the switch 12. The destination address 54 is preferably a virtual address, e.g., the virtual Internet Protocol (VIP) address. The virtual service identifier identifies a desired service provided by at least one of the servers 18. The indications 58 indicate if the clients/applications corresponding to the client identifiers 42 are authorized or not to access the services corresponding to the service identifiers 44. The indications 58 provide either an “allowed” or a “blocked” indication for the associated client identifiers 42 and service identifiers 44. Thus, the virtual ACL 40 provides a filter for use by the managing controller of the switch 12 to control access by any application on any of the clients 14 to any of the services provided by the servers 18. The client-service associations in the virtual ACL 40 can be created/edited by a user/programmer of the switch 12 using the interface 33.

Preferably, as shown, the virtual ACL 40 is organized such that specific permitted associations of clients/applications and regulated services will be analyzed first (e.g., listed first if searched in order), followed by specific denied associations of clients/applications and regulated services, followed by permitted access for all non-regulated services or other transmissions. This may help improve efficiency as it is expected that most access attempts will be for services for which access is permitted. Thus, the virtual ACL 40 includes associations for which access is allowed first, followed by associations for which access is to be blocked. The virtual ACL 40 further includes a final, catch-all entry 59 regarding all other access attempts, either for non-regulated services or other transmissions (e.g., not requesting services). For this final entry, the access is allowed.

Entries in the virtual ACL 40 may link various combinations of the clients 14 and the services provided by the servers 18. For example, more than one client application identifier 42 may access a particular service and the virtual ACL 40 can reflect this by having more than one client application identifier associated with a service identifier 44. Similarly, one client application may be allowed access to multiple services by using a service range. Indeed, ranges of clients 14 and/or services can be provided in the virtual ACL 40 using ranges in the client application identifiers 42 and/or the service identifiers 44. These ranges can use a client address range 80, a client port range 82, a service address range 84, and/or a service port range 86. Thus, as shown, the client-service associations can link any number of the clients 14₁-14₃ to any number of services provided by the servers 18₁-18₃.

Referring also to FIG. 4C, the switch 12 is further configured to translate the virtual ACL 40 into an actual router-executable ACL 120 that the router 36 can implement. The router 36 will be programmed with configuration information including an interface definition and a NAT configuration. The configuration information can include a pointer to an actual ACL to implement, e.g., if multiple actual ACLs may be used. For example, the router 36 can be programmed to implement the actual ACL 120 by being programmed to implement the ACL LST2 (e.g., with commands: ip access group LST1 in; ip access-group LST1 out). If the command for implementing the actual ACL is changed, e.g., to point to LST2 (another actual ACL), then the router 36 will implement that actual ACL. This FIG. 4C shows an exemplary actual ACL 120 specifically configured to be implemented by a Cisco® IOS (12.2.x) router.

As shown, the actual ACL 120 includes router commands 122, 124, 126, 128, 130, 132, and 134. The commands 122, 124 indicate that the host 192.168.10.56 can access the service at 10.13.255.2 port 1251, and vice versa. The commands 126, 128 indicate that applications from any port of subnet clients ranging from 10.13.1.0 through 10.13.1.255 may access the service at 10.13.255.3 port 1251, and vice versa. The command 130 indicates that any application may access the service at 10.13.255.1. The command 132 indicates that any access attempts, that have not been disposed of using the previous commands, for the services ranging from 10.13.255.0 through 10.13.255.127 should be denied. Lastly, the command 134 indicates that for any other communications, that are not seeking access to services managed/regulated by the switch 12, then these communications should be allowed to proceed.

The switch 12 can produce multiple actual ACLs and can replace an existing, online actual ACL with a new actual ACL. The switch 12 can process information from the user or from the processor 30 regarding authorized/unauthorized service accesses and produce a further actual ACL. The switch 12 can produce the further actual ACL offline, in the background so that the switch 12 can continue to handle service requests while the new ACL is being produced. When the new ACL is ready, the switch 12 can modify the configuration of the router 36 to direct the router 36 to implement the new ACL, thus redirecting the router to implement the new ACL without downtime of the switch 12. The switch 12 can also modify the current ACL dynamically if the router 36 supports such editing. One example of modifying the ACL (through an edit to the current ACL or by using a replacement ACL) is for temporal permission to access a service. For example, if a user logs in to a service or an application (aggregate of clients), and possibly provides login information, the switch 12 may authorize the user to access the desired service for a limited amount of time, e.g., two hours. The switch 12 can change the ACL to include the authorization, if necessary, and after the time expires can change the ACL (by editing it or replacing it) to change the status of the access from authorized to unauthorized.

Referring again to FIGS. 2-3 and 4B, the processor 30 is configured to execute a computer-readable and computer-executable software program 31 stored in the memory 32. The memory 32 stores the computer-readable and computer-executable software 31 that is configured to be read and executed by the processor 30 to cause the processor 30 to perform functions described herein, e.g., for managing communications passing through the switch 12. The software program 31 is configured to cause the processor 30 to analyze an incoming service request from the network 16₁ to determine the client identifier, here the network address (e.g., an Internet Protocol (IP) address) and optionally the port number from which the request originated, i.e., the client address 50 and optionally the client port number 52. The program 31 is further configured to cause the processor 30 to determine the virtual service identifier, e.g., the virtual destination address 54 and the virtual destination port number 56, of the service to which the request is destined. The processor 30 searches the virtual ACL 40 for the determined client identifier 42 and determines if any occurrence of this client identifier in the virtual ACL 40 is associated with the destination virtual identifier 44 from the request. If so, then the processor 30 analyzes the corresponding indication 58 to determine if the requested access is authorized (and thus should be allowed) or unauthorized (and thus should be inhibited). If authorized, the processor 30 permits the request to be further processed for transfer to the intended destination. If unauthorized, the processor 30 inhibits the request from being transferred to the intended destination, e.g., by discarding the request.

The processor 30 records pertinent information regarding inhibited access requests. For example, the processor 30 can store the client address and port number, the requested virtual destination address and port number, and the time of day and date. This information may be used, e.g., to determine how often and/or how many times a particular client has requested an unauthorized access generally, to a particular destination address, and/or to a particular port on a particular destination address. Similar information can be determined for a particular client application for a particular client. The processor 30 may take actions based on the number of unauthorized requests exceeding a threshold. For example, the processor 30 could deny even authorized requests from a particular client address and/or port number, provide warnings to a user associated with the client address, and/or provide reports of the unauthorized access attempts, e.g., through the interface 33 and/or to a printer, etc.

A user of the switch 12 can selectively activate the ACL security feature using the interface 33. This “zoning” feature applies security to zones of client applications, e.g., client addresses or ranges of client addresses. The user can interact with the user interface 33 of the switch 12 to select to have the processor 30 screen requests using the virtual ACL 40, or to have the processor 30 process incoming requests without regard to the virtual ACL 40.

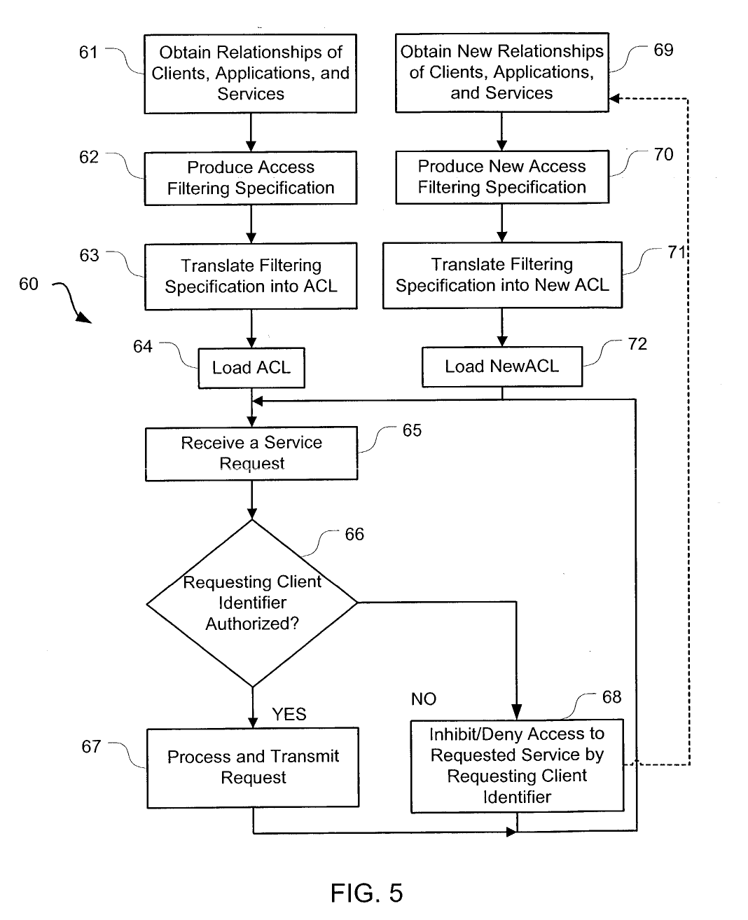

In operation, referring to FIG. 5, with further reference to FIG. 2-4, a process 60 for configuring and using the virtual ACL 40 to provide secure service access using the system 10 includes the stages shown. While for simplicity the following describes the switch 12 as using the virtual ACL 40, in practice the router 36 implements an actual ACL such as that shown in FIG. 4C. The process 60, however, is exemplary only and not limiting. The process 60 can be altered, e.g., by having stages added, removed, or rearranged. The process 60 is for situations where the zoning feature of the switch 12 is active.

At stage 61, a user of the switch 12 provides information regarding permissible and impermissible associations of clients, applications, and services. The user uses the interface 33 to input desired associations of clients and applications with corresponding services and indicia of whether the clients/applications are permitted access to the corresponding services or should be denied access to the services. The user supplies pertinent information such as addresses and optionally port numbers for clients and addresses and port numbers for the services. To do this, the user enters desired client addresses and optionally corresponding port numbers and enters the desired corresponding authorized virtual service addresses and port numbers. Any of the addresses and/or port numbers may be a range of values.

At stage 62, the switch 12 uses the information supplied by the user to produce the access filtering specification 100. The switch 12 assembles the supplied information into a format associating the client(s)/application(s) with service(s) and indications of whether the associations correspond to permissible or impermissible service accesses.

At stage 63, the switch 12 translates the filtering specification into the actual ACL. While it is the actual ACL that the router 36 operates on, the following description discusses the functions performed with respect to the virtual ACL 40 for simplicity. The switch 12 processes the filtering specification information and addresses and port numbers into the client-application identifiers 42 and the service identifiers 44 and into actual router-executable commands. The commands specify the client(s)/application(s) and service(s) and whether the service(s) is(are) accessible or inaccessible for the corresponding client(s)/application(s).

At stage 64, the switch 12 loads the produced actual ACL. The switch 12 stores the actual ACL in the router 36 for reading and execution by the router 36. The configuration information of the router 36 is set to look to the loaded actual ACL, e.g., an ACL LST1.

Shown in parallel with stages 61-64 are stages 69-72 in which new relationship information is obtained and a new actual ACL is produced by the switch 12 and loaded into the router 36. New information may be input by the user through the interface 33. A new ACL may be produced by the switch 12 by editing the currently-used ACL. Alternatively, a second ACL may be produced off line in the background and, once completed, substituted for the currently-used ACL. This can be done by storing the second actual ACL in the router 36 and modifying the configuration information of the router to point to the new ACL, e.g., an ACL LST2. This latter technique may be used if the router 36 does not support dynamic editing of a currently-active ACL, or even if the router does support such editing. Information for a new ACL, e.g., to have the indication 58 indicate that access that was previously allowed is now denied, may be supplied by the switch 12 instead of the user, e.g., if a number of unauthorized access attempts exceeds a threshold as discussed below.

At stage 65, the switch 12 receives a service request in the form of a packet of data via the network 16₁. The switch 12 analyzes the request, and in particular the header of the packet, to determine the client and destination identifiers, here the client address and client port number and the destination address and destination port number.

At stage 66, the switch 12 uses the virtual ACL 40 to determine whether the requesting client identifier is authorized to access the requested service. This can provide a determination of whether the client generally, or the client application specifically, is allowed access to the requested service. The switch 12 searches the virtual ACL 40 for the client identifier, here the client address and port number, in the list of client addresses 50 and port numbers 52. If the switch 12 finds the client application identifier of the request in the virtual ACL 40, then the switch 12 checks the service identifier 44 associated with the found client application identifier 42 in the virtual ACL 40. If the service identifier 44 matches (or, if a range, includes) the requested identifier (here destination address and port number), then the processor 30 examines the indication 58 to determine if the client identifier is authorized access to the intended service. If it is authorized, then the process 60 proceeds to stage 67, preferably regardless of any payload data in the request packet or of any other packet (e.g., independent of password information entered by a user). If the client application identifier of the request is not found in the virtual ACL 40, or is found but is not associated with the service identifier of the request (including checking multiple occurrences of the client application identifier), or if the client identifier is found associated with the destination identifier but the indication 58 indicates that the client application is not authorized to access the requested service, then the process 60 proceeds to stage 68.

At stage 68, the switch 12 inhibits, and preferably denies, access of the requesting client/application to the requested service. The switch 12 logs information regarding the unauthorized request, such as time of day, requesting client address and port number, and requested service address and service port number. The switch 12 can also send a warning message to the requesting client 14 indicating that the requested access was unauthorized and thus not completed. The switch 12 sends reports, e.g., to the user interface 33, regarding unauthorized access attempts, and in particular repeated unauthorized access attempts for the same service and/or from the same client and/or client application. If unauthorized access attempts, e.g., by the same client and/or client application exceed a threshold, the processor 30 can deny all future attempts, even if otherwise authorized (as indicated by the indication 58) by the client and/or client application. In this case, the process 60 proceeds to stage 69 (as indicated by a dotted line) where the change in the status from permissible to impermissible access is provided to the switch for editing the ACL used by the router 36.

At stage 68, in response to determining that the requested access is authorized, the switch 12 processes and transmits the request. The router portion of the switch 12 converts the destination address from the VIP address and port number of the request to an actual address and port number of a server 18 selected by the switch 12 to provide the service. The switch 12 forwards the request, with the actual address and port number substituted for the VIP address and port number, to the network 16₂ for transmission to the appropriate server 18.

The process 60 returns to stage 65 for processing of further service access requests. This return to stage 65 occurs whether the previous request was authorized or not, unless it was an unauthorized attempt that exceeded a threshold of such attempts, in which case the process proceeds to stage 69 as discussed.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. Further, as stated above, the invention is not limited to use with databases or database servers. Servers providing services other than database services are equally acceptable and within the scope of the invention. Also, while the virtual ACL 40 shown in FIG. 4B associates source address and port number to destination virtual address and port number, the virtual ACL 40 could associate only source and destination addresses, or only source and destination port numbers, or other information. Further, the information searched for in the virtual ACL 40 does not have to be identically the information in the incoming request. There may be a conversion of information from that in the request to source and/or destination information. The searched-for data are related to the data in the request, but may or may not be identical to the data in the request, e.g., in a packet header.

The virtual ACL 40 was discussed above as providing associated client identifiers and service identifiers, and indications of whether the associations were authorized (allowing access) or unauthorized (inhibiting access). An ACL could be configured in a variety of different ways to provide such information. For example, the ACL could store only associations of authorized for access, or only associations for which access should be inhibited. Thus, the indications 58 could be eliminated and the processor 30 could attempt to locate an association and act appropriately depending upon whether the association is found and upon whether the list is of authorized or unauthorized associations.

Further, the virtual ACL 40 may store actual destination identifiers instead of virtual identifiers, and the switch 12 can evaluate whether access is authorized based on the actual, instead of virtual, service identifiers. In this case, the switch's router can perform NAT on incoming service requests to convert incoming virtual identifiers into corresponding actual service identifiers (e.g., actual addresses and port numbers). The processor can use the client identifier and the actual service identifier to examine the virtual ACL 40, that stores associations of client identifiers and actual service identifiers, to determine whether the incoming request is authorized or not for accessing the intended service. Using virtual service identifiers, however, is preferred to determine whether to allow or inhibit access before performing NAT, if at all.

What is claimed is:

1. A system for use in a network that includes a plurality of clients and a plurality of servers configured to implement service applications, the system comprising:
at least one interface configured to communicate with the clients and the servers;
a memory that contains computer-readable and computer-executable instructions and an access control list with sets of associated client identification and destination service identification; and
a processor coupled to the at least one interface and to the memory and configured to read the instructions, the instructions being configured to cause the processor to:
analyze an incoming service-access request, received by the at least one interface, for source identification associated with a source of the service-access request and destination service identification associated with an intended destination of the server-access request, the source identification comprising at least one of network source address and a source port number, and the destination service identification, comprising at least one of a destination service address and a destination port number; and
determine whether indicia of the source identification and of the destination service identification from the service-access request is included in the access control list in a manner that indicates that the source of the service-access request is authorized for access to a service associated with the destination service identification.

2. The system of claim 1 wherein the instructions are configured to cause the processor to analyze the incoming service-access request for a virtual destination address as the destination identification information.

3. The system of claim 2 wherein the instructions are further configured to cause the processor to determine whether the indicia of the source identification is stored in the access control list in association with the indicia of the destination service identification and an associated indication of whether the requested access is authorized.

4. The system of claim 3 wherein the instructions are further configured to cause the processor to inhibit the service-access request from reaching a server associated with the destination service identification if the processor determines that the source of the service-access request is unauthorized for access to a service associated with the destination service identification.

5. The system of claim 4 wherein the instructions are configured to cause the processor to inhibit the service-access request if the processor fails to find the indicia of the source identification in the access control list, or finds the source identification in the access control list but the indicia of the destination service identification is not associated with the source identification, or finds the source identification in the access control list associated with the indicia of the destination service and an associated indication that indicates that the requested access is unauthorized.

6. The system of claim 1 wherein the access control list contains indicia of a range of at least one of source address, source port number, destination service address, and destination service port number.

7. The system of claim 1 wherein the instructions are further configured to cause the processor to inhibit the server-access request from reaching the server associated with the destination identification indication if the processor fails to determine that the indicia of the network source address indicated by the server-access request is included in the access control list in association with the indicia of the destination identification information indicated by the server-access request.

8. A method of selectively conveying communications from a client toward a service in a packet-switched network, the method comprising:
receiving a data packet;
determining, from a header of the packet, a source identifier and a destination service identifier, the source identifier comprising at least one of a network address and a source port number, and the destination service identifier comprising at least one of a destination address and a destination port number;
determining, using stored relationships of indicia of source identifiers and indicia of destination service identifiers, whether a client associated with the source identifier is authorized to access a service associated with the destination service identifier; and
transmitting data contained in the packet toward the service if the client associated with the source identifier is authorized to access a service associated with the destination service identifier.

9. The method of claim 8 wherein the transmitting occurs regardless of values of payload data in the packet.

10. The method of claim 8 further including inhibiting the data contained in the packet from being transmitted toward the server if the searching fails to find that the client associated with the source identifier is authorized to access a service associated with the destination service identifier.

11. The method of claim 7 wherein the determining includes analyzing an authorization indication associated with the stored relationships.

12. A system for selectively conveying communications from clients toward servers, that provide services, the system comprising:
at least one interface configured to communicate with the clients and the servers; and
means for determining whether an incoming communication, that includes logistical information and substantive information, is from one of the clients that is authorized to access a service, provided by at least one of the servers, to which the communication is intended, the determining being independent of the substantive information contained in the communication.

13. The system of claim 12 wherein the communication comprises a packet of data including header information and payload data and wherein the determining means performs the determining based only on the header information.

14. The system of claim 12 wherein the determining means performs the determining using stored authorization associations of indicia of client identifiers and indicia of corresponding authorized services.

15. The system of claim 14 wherein the determining means performs the determining using stored authorization associations of indicia of at least one of client network addresses and port numbers.

16. The system of claim 12 further comprising means for inhibiting the communication from reaching the intended service if the client from which the communication came is unauthorized to access the intended service.
